(19) United States
(12) Patent Application Publication
(10) Pub. No.: US 2002/0090600 A1
(43) Pub. Date: Jul. 11, 2002

(54) Method and apparatus for one-key learning with an automated tutor

(76) Inventor: Charles Alexander Grant, Kensington, CA (US)

Correspondence Address: Charles A. Grant, Hotmath.com Inc., 18 Sunset Drive, Kensington, CA, 94707, US

(21) Appl. No.: 09/961,045

(22) Filed: Sep. 20, 2001

Related U.S. Application Data
(60) Provisional application No. 60/234,455, filed on Sep. 21, 2000.

(51) Int. Cl. G09B 7/00

(52) U.S. Cl. 434/322; 434/365

(57) ABSTRACT

A method for remote learning that simulates what the human tutors do as they help explain homework problems. It enhances the self-teaching capabilities of students. It contains hints which are helpful clues for students who don't know how to proceed. These hints suggestion enable the student to proceed with their own paper and pencil solution.

### FIELD OF THE INVENTION

The field of the present invention relates to an intelligent web-based tutoring system, whereby educational material can be authored, stored, customized and delivered over the world-wide-web.

### RELATED APPLICATIONS

This application is related to the co-pending applications of the applicant. filed with the present application and assigned to the assignee of the present application entitled, Method and Apparatus for Automating Tutoring for Homework Problems; Method and Apparatus for Acquisition of Educational Content; Method and Apparatus for Delivery of Educational Content, the disclosures of which are hereby incorporated by reference.

### BACKGROUND OF THE INVENTION

High-school and college students are often discouraged from continuing with math and science courses because the material seems too difficult. Many of these students fail to reach their potential for understanding and succeeding in math and math-related studies, because they are not as fortunate as others who have math-talented relatives, friends, or tutors who can help them.

The key advancement over the state of the art of internet tutoring is that the present invention does what the human tutors do for the most part, namely simulates a tutor as it explains homework problems.

The present invention was created by teachers who recognize that all students do not understand every lesson in the class time allotted. The guideline for this invention is that Socratic solutions are the best method of learning how to solve problems.

This invention was designed for the student in class who needs a little more help understanding how to do the homework. Maybe this student misunderstood something in class, got confused, or simply missed the class. And maybe this student can't come to office hours, and doesn't have a friend or relative available to help right now. And can't afford a tutor.

In recent years we have experienced a change in student attitudes, whereby when a student gets stuck on the homework, the student is much more likely to stop working on it. The student either blames the teacher or simply doesn't care.

The educational content is primarily intended to enhance the self-teaching capabilities of students. As such, it contains hints which are helpful clues for students who don't know how to proceed. When the select the ‘Hint’ button, a suggestion will appear. This suggestion enables the student to proceed with their own paper and pencil solution Students who don't need a hint may skip it.

Often, more then one of the suggestions may be correct. When a student makes a choice, a response appears. To enhance the learning experience, students can try any or all of the choices and internalize all responses. Some answers suggest that the student proceed on their own. In case the student knows the answer, he/she can proceed to the next step without answering.

A solution can be restarted by selecting the ‘restart’ button and going back to the beginning. Alternatively, students can step back one step by selecting the ‘back’ button.

At the end of each solution, students are requested to ‘grade’ the solution. This feature enables the collection of important marketing statistics. After grading the solution students are referred by to the problem index.

The delivery system is can also be used to evaluate existing solutions. Students can start from an existing solution and mark on it the steps defined by the delivery system. Before moving to the next step, all possible answers can be examined and compared. This capability further enhances the understanding of the subject matter and improves the capabilities of students to generate solution ideas.

### SUMMARY OF THE INVENTION

The preferred embodiment of the present invention offers tutorial solutions for many of the homework problems in popular math and science textbooks. We know that EVERY student can use some help with homework from time to time. The kind of help that EXPLAINS in detail how to solve problems, so you can learn to solve others like it.

The present invention seeks to provide thoughtful, encouraging, tutorial solutions that enhance learning. It is primarily helpful for the “B” and “C” students. The “A” students might also use our site to check their work. It is expected that students will use the invention when stuck on a problem, need help, or simply review before an exam. A way to think about the solutions stored by the present invention, one can imagine what a teacher would say when a student comes to office hours and says: “I'm having trouble with this problem.”

The present invention also provide added value to parent, who can now have fun working on math problems with their students. Parents don't need to be embarrassed that they don't remember the details of a methodology or a specific solution. Student should no longer suffer from rustiness of their parent.

The tutorial solutions are presented in a way that a paid tutor might. Cognitive scientists believe that tutorial explanations of solutions is the state-of-the-art method for learning math and science.

### BRIEF DESCRIPTION OF THE DRAWINGS

FIG. 1 shows the relationship between one-click tutoring participants.

FIG. 2 shows the one-click tutoring method.

FIG. 3 shows an example application of the one-click tutoring method

### DETAILED DESCRIPTION OF THE PREFERRED EMBODIMENTS

A student using tutorial software to receive assistance in the solving of homework problems is faced with a space requirement for the computer screen, keyboard, mouse pad, mouse, textbook, pencil, notebook, and paper. With so many objects to manage, a tutorial screen that requires mouse manipulations may be inconvenient, cumbersome and perhaps even a deterrent from using the system, especially if extended periods of work with the tutorial system are physically uncomfortable.

One can imagine a teenager leaning back in a chair, feet propped up on a nearby bed, textbook and homework paper in his/her lap, homework assignment notebook open on the desk, and the computer screen, keyboard, mousepad and mouse nearby on a desk with other books, papers, etc.

The present invention alleviates the need for using the mouse during a tutorial session. The user interface of the present invention in the tutorial system is enhanced by allowing a student to proceed through each solution merely by tapping the space bar on the keyboard.

This may provide a more comfortable and more convenient method of entering commands at the computer screen in comparison to the requirement to position the mouse over a small “button” on the screen and then click.

Thus, with one-click learning, the student user presses the space bar to: advance from a step to the next hint; advance from a hint to the next step; advance from a query to the first query choice; advance from a query choice to the response to that choice; advance from a response to the next query choice. And so on.

At the end of a solution, a “one-click” will take the student to the next problem in sequence in the textbook.

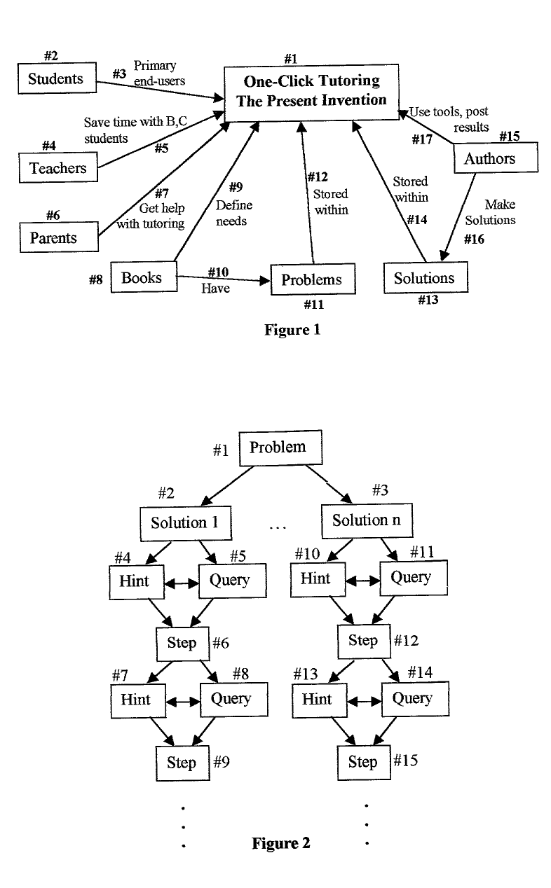

Turning now to FIG. 1, the one-click tutoring method #1, is the focal point of a tutoring process integrating numerous entities. Students #2 are the primary end-users #3 of the present invention. Teachers #4 use the present invention to save time #5 when going over problematic materials. This is achieved by being provided with the targeted content of hints and problem steps that they would otherwise have to develop themselves in real-time. Parents #6 use the one-click method to get help with tutoring their child #7 and efficiently navigate through the solution and avoid confusion often created by not being current with the study material. The materials is organized according to the text-books #8 used by the teacher in the class. Thus, these books dictate the content of the tutorials #9. These books have #10 homework (and other excersize) problems #11 which are stored by the present invention #12 in electronic form. Each of these problems is associated with a solution #13, which are stored by the present invention #14 in electronic form. Students who, as part of their homework and exam preparation, are required to find solutions to these problems are using the present invention to help them to their task.. The solutions are composed #16 by authors #15 who use tools that are part of the present invention to create and store these solution #17.

Turning now to FIG. 2, a problem #1, originating from a text book, consists of a problem identification followed by a list of solutions #2,#3. Upon tapping the spacebar a hint #4,#10 or a query #5,#11 is presented. Upon the next tap a step is presented #6,#12. Upon the next tap a hint #7,#13 or query #8,#14 is presented, followed, upon the next tap, by a step #9,#15. HM/SL, the disclosures of which are hereby incorporated by reference, defines a method of coding each of these items that is simple and allows figures and equations generated using Equation Editor (such as commonly used in Microsoft Word) to be integrated easily into the item. Figures and graphs can be inserted in solutions.

Hints are used to guide the student who is having a difficulty when solving a problem A hint should describe what a tutor would say to a student having trouble with the problem to get them going. Generic statements that repeat the problem statement are not helpful (e.g., “Solve the equation”). Also, at the beginning of a step following a hint, the text amplifies on the hint as the beginning of the step: a student may or may not have actually requested a hint so it must be repeated. Sometimes the problem is so elementary that a hint just doesn't make sense. In that case, a hint may comprise of a very brief statement (e.g., “Substitute”).

Queries or Questions are used in addition to the hints; Socratic questions may be used as well. Questions are good learning tools and get the student involved in using the solutions. A question includes a textual followed by a series of two or more responses, each of which is labeled as either correct or incorrect. A question may also contain formulas and figures, which are built in the same way that formulas and figures within hints and steps are built.

The tools used by the solution authors to develop solutions are standard word-processing software (such as Mocrosoft Word), a well defined format (HMSL), and a compilation tool converting the HMSL formatted word-processing documents into plain-text XML documents that can be transferred over the internet.

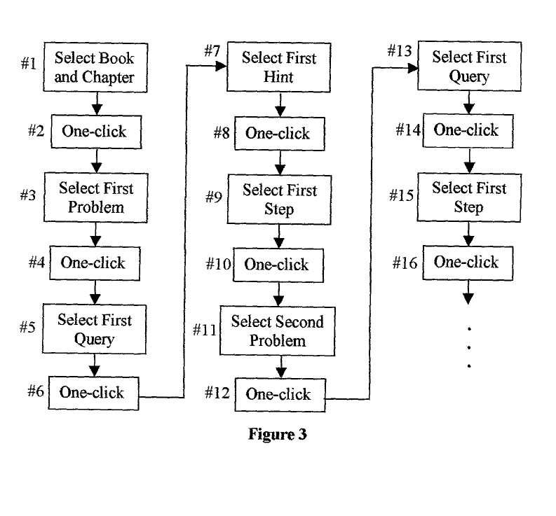

Turning now to FIG. 3, an alternative to the non-deterministic method presented in FIG. 2 is presented, which enables iterating through the tutorial in a sequential fasion, using a single-click device such as space-bar or mouse-button. Initially, the user select a book and a chapter #1. Next, a single click #2 displays the first problem #3 in this chapter. Next, a single click #4 displays the first query #5 (to engage the student). Next, a single click #6 displays the first hint #7 related to the query. Note that it is possible to skip the query directly to the hint. Next, a single click #8 displays the first step #9. Note that both the hint and/or query may be skipped to directly arrive at the step. Next, if more step exist for this problem, the next click will display the next query and repeat the above scenario. Otherwise, a single click #10 displays the second problem #11. Next, a single click #12 displays the first query of the second problem #13. Next, assuming the second problem has no hint associated with the first step, the subsequent click #14 displays the first step of the second problem #15. Subsequent clicks #16 continue iterating through the problem, and subsequently through other problems, according to the content stored in the database, the disclosures of which are hereby incorporated by reference, in a fasion similar to above scenario.

Each hint and step is associated with a student-level metrics. At least three levels are used: beginner, intermediate and advanced. The present invention stores for each student its current level. Students's level can change by means of direct input from the student, or by means of counting the number of times certain hints or steps are requested. Each step may have different subsequent steps to be retrieved by the one-click iterator. The system is capable of presenting a hint or a step that best fits a student level as recorded in the student's profile.

Socratic questions could be used as well. A Hotmath Socratic question consists of the QUESTION (a posed question intended to help the student think through the next concept in the solution) and a series of pairs (GUESSES and GUESS-RESPONSES).

For example: QUESTION: What factoring method do you think would be best here?

GUESS 1: Difference of squares.

GUESS-RESPONSE 1: No, this binomial expression is not a difference of squares: there are three terms.

GUESS 2: Quadratic formula.

GUESS-RESPONSE 2: Yes, for binomial expressions of this complexity, the quadratic formula works very well.

We claim:

1. A one-click learning method, for tutoring students comprising of the steps of
specifying, through a web-browser pointing to a web-site, one or more problems that are publicly available from sources other than the said web-site;
retrieving, for the said problems, one of more hints helping students to arrive at intermediate or final steps for arriving at a solution; and
retrieving, for the said problems, one of more intermediate or final steps for arriving at a solution.

2. A method as in claim 1 wherein the said problems are available in an article or quiz published in a newspaper or magazine.

3. A method as in claim 1 wherein the said problems are available in a text book.

4. A method as in claim 3 wherein the said text book is an engineering text book.

5. A method as in claim 3 wherein the said text book is a junior high-school level text book.

6. A method as in claim 3 wherein the said text book is a high-school level text book.

7. A method as in claims 5,6 wherein the subject matter of the said text book is math or science text.

8. A method as in claim 1 wherein each said problem is associated with one or more hints.

9. A method as in claim 1 wherein each said step is associated with one or more hints.

10. A method as in claim 1 wherein each said step may have one or more possible subsequent steps.

11. A method as in claims 9,10 wherein each said step and said hint is associated with a student level metrics.

12. A method as in claims 11 wherein the mapping from hints and steps to subsequent hints and steps depends on the student's level as recorded by the student's profile.

13. A method as in claim 1 wherein the said hints and said steps are authored by subject matter tutors utilizing state or the art personal computers.

14. A method as in claim 1 wherein the said hints and said steps are publicly available from sources other than the said web-site.

15. A method as in claim I wherein each web-page presented using a said web-browser may contain banner ads.

16. A method as in claim 1 wherein the retrieval of the hints and problems is enhanced with student-level metrics.
